(19) United States
(12) Patent Application Publication
(10) Pub. No.: US 2003/0009119 A1
(43) Pub. Date: Jan. 9, 2003

(54) Method and apparatus for stimulating angiogenesis and wound healing by use of external compression

(76) Inventors: Roger D. Kamm, Weston, MA (US); Jonathan P. Gertler, Weston, MA (US)

Correspondence Address: C. Hunter Baker, M.D., Ph.D., Choate, Hall & Stewart, 53 State Street, Exchange Place, Boston, MA, 02109, US

(21) Appl. No.: 09/815,528

(22) Filed: Mar. 23, 2001

(51) Int. Cl. A61H 19/00

(52) U.S. Cl. 601/149

(57) ABSTRACT

A system for delivering external compression in order to stimulate angiogenesis or promote wound healing is provided. External compression causes changes in hemodynamic forces (e.g., shear stress) in the vasculature that are sensed by endothelial cells and smooth muscle cells. The stimulated cells respond by secreting various angiogenic factors and growth factors such as platelet-derived growth factors A and B and basic fibroblast growth factor. The inventive method may be used to treat patient suffering from diseases characterized by low blood flow such as peripheral vascular disease and coronary artery disease. A apparatus for delivering external compression to induce angiogenesis or promote wound healing is also provided.

### BACKGROUND OF THE INVENTION

External compression techniques including enhanced external counterpulsation (EECP) have been used for many years to increase circulation and provide support for a failing heart. EECP generally involves placing inflatable cuffs on the low half of a patient's body and pressurizing and depressurizing the cuffs out-of-phase with the left ventricle. Pressurization of the cuffs during diastole when the aortic valve is closed leads to collapse of the arteries causing blood to flow retrograde from the extremities to the heart. The resulting increased diastolic pressure has been shown to increase perfusion of vital organs including the heart. Measurements performed by Applebaum et al. have demonstrated increases in mean flow velocities of 19% and 22% in the renal and carotid arteries, respectively (Applebaum et al. “Sequential external counterpulsation increases cerebral and renal blood flow” American Heart Journal 133(6):611-615, June 1997; incorporated herein by reference). Just prior to systole, the cuffs are depressurized to allow the arteries to refill. Depressurization of the cuff at this time is thought to lead to a rarefaction wave which propagates back to the heart resulting in a decrease in cardiac afterload. As in the case of coronary perfusion enhancement, the benefits of afterload reduction are relatively small, and EECP has not found general acceptance as a cardiac assist procedure.

One of the best ways of alleviating the problems of low blood flow and decreased perfusion is through angiogenesis in order to create new blood vessels to feed the affected area of the body. Angiogenesis has been found to be important in many pathological conditions such as cancer and retinal neovascularization as well as in normal physiological states such as wound healing and development. Angiogenesis is a complex biological process involving many factors and cell types to produce new blood vessels. Many natural factors have been found to have angiogenic activity including platelet-derived growth factor, fibroblast-derived growth factor, epidermal growth factor, vascular endothelial-derived growth factor, etc. Arterial and venous endothelial cells and smooth muscle cells have been found to be sensitive to fluid dynamic shear stress and mechanical strain and to release pro-angiogenic factors (e.g., platelet-derived growth factors A and B, and basic fibroblast growth factor) in response to such stimuli (Davies “Mechanisms involved in endothelial responses to hemodynamic forces” Atherosclerosis 131:S15-S17, June 1997; Diamond et al. “Tissue plasminogen activator messenger RNA levels increase in cultured human endothelial cells exposed to laminar shear stress” Journal of Cell Physiology 143:364-371, 1990; Hseih et al. “Shear stress increases endothelial platelet-derived growth factor mRNA levels” American Journal of Physiology 260:H642-H646, 1991; Malek et al. “Fluid shear stress differentially modulates expression of genes encoding basic fibroblast growth factor and platelet-derived growth factor B chain in vascular endothelium” Journal of Clinical Investigation 92:2013-2021, 1993; Mason “The ins and outs of fibroblast growth factors” Cell 78(4):547-552, August 1994; Mitsumata et al. “Fluid shear stress stimulates platelet-derived growth factor expression in endothelial cells” American Journal of Physiology 265(1):H3-H8, July 1993; Sumpio “Hemodynamic forces and the biology of the endothelium: signal transduction pathways in endothelial cells subjected to physical forces in vitro” Journal of Vascular Surgery 13(5):744-746, May 1991; Ichioka et al. “Effects of shear stress on wound-healing angiogenesis in the rabbit ear chamber” Journal of Surgical Research 72:29-35, 1997; each of which is incorporated herein by reference). Shear stress is also instrumental in the control of nitric oxide, endothelin-1, transforming growth factor•₁, and a host of others, many of which may also contribute to angiogenesis.

Although in pathological conditions such as cancer one would like to inhibit the growth of new blood vessels to prevent the growth and spread of cancerous cells, many patients with vascular disease such as coronary artery disease, peripheral vascular disease, diabetes, and atherosclerosis would benefit from the formation of new blood vessels. These new blood vessels would provide better perfusion of the affected area and would lead to the alleviation of symptoms including claudication, numbness, coldness, loss of sensation, and pallor. Currently patients with mild to moderate peripheral vascular disease are advised to exercise the affected area to increase blood flow, and vascular operations to replace diseased vessels with grafts are reserved for more severe cases.

There remains a need for a system of inducing angiogenesis in patients with wounds or vascular disease via a non-invasive method. This system would provide a more pro-active approach to patients with mild to moderate disease and allow for the treatment of a patient with more severe disease without the risks of operations.

### SUMMARY OF THE INVENTION

The present invention provides a system for inducing angiogenesis through endogenous pathways by stimulating endothelial cells, smooth muscle cells, or other cells to produce angiogenic factors. Endothelial cells are known to respond to changes in their environment such as shear stress, mechanical strain, and other hemodynamic forces and produce various angiogenic factors. By altering the shear stress or other hemodynamic forces experienced by the endothelial cells or smooth muscle cells using external compression, one may induce these cells to produce the desired factors and thereby induce angiogenesis.

Any form of external compression may be used which leads to a change in the shear stress or other hemodynamic forces sensed by the endothelial cells, smooth muscle cells, or other cells and leading to the production of angiogenic factors. The maximum pressure needed to attain such a change in the shear stress is typically below that normally used in EECP and other cardiac assist devices. The compression may be applied to the body in a graded and/or sequential manner.

In one aspect, the present invention provides a method of treating a disease characterized by low blood flow (e.g., peripheral vascular disease, coronary artery disease, atherosclerosis, etc.) by inducing angiogenesis. A patient suffering from a disease characterized by low blood flow is provided, and a compression apparatus which can provide external compression is attached to the patient's body. The apparatus is used to compress at least one part of the pateint's body in a manner sufficient to induce angiogenesis. Without wishing to be bound by a particular theory, the external compression is thought to induce angiogenesis by altering the shear stress or other mechanical force experienced by the cells of the patient's vasculature. This change in shear stress leads to the production of various angiogenic factors by the endothelial cells, and these factors subsequently act on various cells to induce the growth of new blood vessels.

The pressure applied to the patient using external compression is typically less than 300 mm Hg. The resulting change in shear stress in certain preferred embodiments is a change in the sign of the stress indicating a change in the direction of the flow of blood in the vessels. In another preferred embodiment, the shear stress is changed in the vessels by 50%, more preferably 100%, more preferably 200%, and most preferably 400%. In another preferred embodiment, the compression applied to the body part is graded (i.e., the maximum level of pressure applied is greatest in the periphery and falls off in the direction of the heart) and/or sequential (i.e., the pressure wave starts peripherally and proceeds proximally).

In a preferred embodiment, the angiogenic factors produced by the vascular cells in response to the external compression include, but are not limited to, growth factors (e.g., platelet-derived growth factor, fibroblast-derived growth factor, epidermal growth factor, vascular endothelial-derived growth factor, transforming growth factor•₁, etc.), cytokines, prostaglandins, leukotrienes, endothelin-1, and nitric oxide (NO). In a preferred embodiment, the cells responding to the change in hemodynamic factors and responsible for producing the angiogenic factors may be endothelial cells, muscle cells, fibroblasts, epithelial cells, or smooth muscle cells.

In another preferred embodiment, the patient being treated using the inventive method suffers from a wound and would benefit from enhanced wound healing. The wound may have been caused accidentally (e.g., abrasion, cut, broken bone), intentionally (e.g., surgical wound), or by a disease process (e.g., infarction). The factors produced by the inventive method are not limited to angiogenic factors but may include other factors that might contribute to wound healing (e.g., cytokines, prostaglandins, leukotrienes, growth factors, chemotaxis factors, etc.). These factors may be produced within the wounded tissue itself, or outside the wounded tissue and transported to the site of injury.

In another aspect, the present invention provides an apparatus for providing external compression so that angiogenesis is induced. The apparatus comprises a fluid or gas, a compression structure for receiving and compressing the fluid or gas, and a control means for controlling the inflation and deflation of the compression structure. Optionally, the apparatus may contain other diagnostic and control features such as a blood oxygen detector, a pulse oximeter, EKG detector, a blood pressure detector, doppler flow probe, etc. In certain particularly preferred embodiments, the deflation and inflation of the compression structure is synchronized to the cardiac cycle. Preferably, the compression phase (i.e., inflation of the compression structure) is anti-phase to left ventricle systole. In another particularly preferred embodiment, the gas or fluid is withdrawn from the compression means using a vacuum pump or a negative pressure reservoir.

### Definitions

The term animal, as used herein, refers to humans as well as non-human animals, including, for example, mammals, birds, reptiles, amphibians, and fish. Preferably, the non-human animal is a mammal (e.g., a rodent, a mouse, a rat, a rabbit, a monkey, a dog, a cat, a primate, or a pig). An animal may be a transgenic animal.

The term compression, as used herein, refers to the application of pressure to an area of the body. Preferably, the compression is exerted externally. The compression may be applied to any part of the patient's body. In a particularly preferred embodiment, the pressure used to provide the compression is less than 300 mm Hg, more preferably less than 200 mm Hg, and most preferably less than 150 mm Hg.

The term factor, as used herein, refers to any molecule, peptide, protein, nucleic acid, or natural product that is produced or secreted by cells responding to the external compression. Examples of factors included, but are not limited to, mitogens, growth factors, platelet-derived growth factors A and B, basic fibroblast growth factor, epidermal growth factor, vascular endothelial-derived growth factor, nitric oxide, endothelin-1, transforming growth factor•₁, prostaglandins, leukotrienes, and cytokines. In certain preferred embodiments, the factor is an angiogenic factor. In other preferred embodiments, the factor is known to promote wound healing.

The term graded, as used herein, refers to a form of compression wherein the pressure applied at a distal region is greater than the pressure applied at a more proximal region. For example, the pressure applied at the ankles is greater than the pressure applied at the calves. In a particularly preferred embodiment the difference between the distal and proximal ends of the compression region is between about 10 mm Hg and about 100 mm Hg, more preferably the difference is between about 30 mmHg and about 80 mm Hg, and most preferably the difference is between about 40 mm Hg and about 60 mm Hg.

The term hemodynamic force, as used herein, refers to any force related to or resulting from blood flow. Hemodynamic forces include, but are not limited to, fluid shear stress, solid stress, blood flow, and pressure. In a particularly preferred embodiment, the hemodynamic forces are experienced by the cells that subsequently produce the desired factors. In a particularly preferred embodiment, the hemodynamic force is shear stress.

The term sequential, as used herein, is synonymous with wave-like and refers to a form of compression wherein a wave of compression is generated. For example, compression is first applied distally and subsequently is applied further and further proximally. The compression wave may be retrograde or antegrade with respect to normal blood flow. Preferably, the compression wave is retrograde with respect to normal blood flow. In a preferred embodiment, the speed of the wave of compression resulting from sequential compression is comparable to the speed of propagation of pulse waves through the peripheral arteries. In another preferred embodiment, the speed of the wave ranges from about 2 m/s to about 15 m/s, more preferably from about 5 m/s to about 10 m/s.

### BRIEF DESCRIPTION OF THE DRAWING

FIG. 1 shows (a) the 30 element model of the arterial system. Dashed elements represent those that are reflected by symmetry and are not explicitly computed. b) Division of lower arterial tree elements into three pressurization regions for EECP model. The figure is drawn to scale.

FIG. 2 depicts the application of external pressure with respect to time during the heart cycle. Parameter values are given in Table 3.

FIG. 3 shows the pressure at several locations in the arterial tree with normal parameter values (“normal”) and parameter values simulating compromised ventricular function (“diseased”). One complete cardiac cycle at steady state is shown, beginning with the onset of systole. Parameter values as given in Table 3. Greater augmentation, as evidenced by greater values of the effectiveness ratio, is seen in the simulated disease cases: (a) radial artery, normal. Method for computing “effectiveness ratio” shown; (b) aortic root, normal; (c) radial artery, diseased; and (d) radial, aortic, and abdominal pressures, diseased.

FIG. 4 is a graph of cross-sectional area plotted versus time for several cardiac cycles following the onset of EECP at the midpoint of the (a) lower abdomen, (b) thigh, and (c) calf compression zones, respectively, normalized with respect to the cross-sectional area without external compression at 100 mm Hg (Aₒ). Light lines: no external compression. Dark lines: with external compression.

FIG. 5 is a measure of arterial wall shear stress [Eq. (23)] plotted versus time for several cardiac cycles following the onset of EECP at the midpoint of the (a) lower abdomen, (b) thigh, and (c) calf compression zones, respectively. Magnitude is increased by more than 3-fold (much more in the lower abdomen) and flow reversal is evident. Light lines: no external compression. Dark lines: with external compression. Note that mean shear stress in the normal arterial circulation is generally in the range of 1.5 Pa.

### DETAILED DESCRIPTION OF CERTAIN PREFERRED EMBODIMENTS OF THE INVENTION

The present invention provides a system for inducing angiogenesis or wound healing by the use of external compression. Compression of a part of the patient's body is thought to lead to changes in hemodynamic forces experienced by cells of the vasculature which in turn respond to the change by producing and secreting various factors. These factors may act locally or distantly to induce angiogenesis or wound healing and thereby prevent or reduce the patient's disease.

Patients

The patient treated by the inventive external compression method of inducing angiogenesis may be any animal including humans suffering from any pathological or physiological state that would benefit from the growth of new blood vessels. In a particularly preferred embodiment, the patient being treated by the inventive method suffers from low blood flow and/or reduced perfusion of a limb, organ, tissue, or group of cells. Some disease states that are characterized by low blood flow include, but are not limited to, cardiovascular disease, coronary artery disease, peripheral vascular disease, peripheral vascular disease resulting from diabetes (Type I or Type II), peripheral atherosclerotic disease, atherosclerosis, thromboangiitis obliterans, Raynaud's phenomenon, arteritis, vasculitis, thromboembolic disesase, intermittent ischemic pain, claudication, intermittent claudication, gangrene, vascular insufficiency, resting pain, microemboli, etc. The inventive method preferably helps to increase perfusion of the affected area by the formation of new blood vessels. In certain preferred embodiments, these newly created blood vessels are collateral blood vessels that by-pass an obstructed or partially obstructed vessel.

In another preferred embodiment, the patient has a wound or injury, and the inventive method of external compression is used to promote wound healing. The promotion of wound healing is preferably by the stimulation of growth of new blood vessels; however, the inventive method is not limited to inducing the growth of new blood vessels but could be due to the action of induced growth factors, mitogens, cytokines, and other regulatory molecules on the cells of the injured tissue. The wound may be any injured or damaged organ, tissue, cell, groups of cells, body part, or limb. The wound may have been created intentionally as in a surgical incision, or the wound may have occurred via a disease process such as a myocardial infarction due to coronary artery disease. The wound may also be a cut, scratch, abrasion, bruise, broken bone, etc.

The inventive method may also be applied to non-human animals. In a preferred embodiment, the inventive method is used to stimulate angiogenesis or promote wound healing in mammals. In a particularly preferred embodiment, the mammals are domesticated. As in the case of humans, animals being treated by the inventive method suffer from low blood flow to an affected area or have a wound or injured tissue.

Compression

A compression apparatus is attached to at least one body part of the patient being treated by the inventive method. Preferably, the apparatus is attached to the outside of the patient and thereby induces angiogenesis or wound healing in a non-invasive manner. The apparatus is preferably attached relatively close to the area of low blood flow so that any induced, short-lived factors produced by the compression are delivered to the affected area before significant degradation. The compression apparatus may be attached to the patient using any means known in the art. These may include Velcro® straps, zippers, elastic bands, buttons, snaps, etc.

The compression apparatus preferably compresses the blood vessels of the body part to which the apparatus is attached. This leads to a change in the environment (e.g., hemodynamic forces, mechanical strain, blood flow, pressure, shear stress) of the cells of the vessels (e.g., endothelial cells, fibroblasts, smooth muscle cells, etc.). Many of these cells are known to respond to changes in their environment. For example, endothelial cells are known to respond to changes in shear stress (Davies “Mechanisms involved in endothelial responses to hemodynamic forces” Atherosclerosis 131:S15-S 17, June 1997; Diamond et al. “Tissue plasminogen activator messenger RNA levels increase in cultured human endothelial cells exposed to laminar shear stress” Journal of Cell Physiology 143:364-371, 1990; Hseih et al. “Shear stress increases endothelial platelet-derived growth factor mRNA levels” American Journal of Physiology 260:H642-H646, 1991; Malek et al. “Fluid shear stress differentially modulates expression of genes encoding basic fibroblast growth factor and platelet-derived growth factor B chain in vascular endothelium” Journal of Clinical Investigation 92:2013-2021, 1993; Mason “The ins and outs of fibroblast growth factors” Cell 78(4):547-552, August 1994; Mitsumata et al. “Fluid shear stress stimulates platelet-derived growth factor expression in endothelial cells” American Journal of Physiology 265(1):H3-H8, July 1993; Sumpio “Hemodynamic forces and the biology of the endothelium: signal transduction pathways in endothelial cells subjected to physical forces in vitro” Journal of Vascular Surgery 13(5):744-746, May 1991; Ichioka et al. “Effects of shear stress on wound-healing angiogenesis in the rabbit ear chamber” Journal of Surgical Research 72:29-35, 1997; each of which is incorporated herein by reference). In response to the change, the cells produce a variety of factors including platelet-derived growth factors A and B and basic fibroblast growth factor.

Any pattern of pressure application may be used in the inventive method. Preferably, the pressure application results in a change in a hemodynamic force experienced by the cells of the blood vessels being compressed as well as those up- and downstream of the compression site. In a particularly preferred embodiment, the endothelial cells are stimulated by a change in shear stress. Preferably, the change in shear stress results in a change in the sign of the shear stress indicating a change in the direction of blood flow. In other preferred embodiments, at least a 25% change in shear stress is observed, more preferably at least a 50% change, and most preferably at least a 100% change.

In certain preferred embodiments, the maximum pressure applied by the compression apparatus is greater than peak systolic pressure. In other preferred embodiments, the maximum pressure applied is less than 300 mm Hg, more preferably less than 200 mm Hg, and most preferably less than 150 mm Hg.

In certain preferred embodiments, graded pressure application is used in the inventive method. Graded refers to the application of more pressure distally than that applied proximally. In certain particularly preferred embodiments, the pressure difference between the distal and proximal ends of the compression region is in the range from about 20 mm Hg to about 100 mm Hg, more preferably from about 30 mm Hg to about 70 mm Hg, and most preferably from about 40 mmHg to about 60 mm Hg.

In other preferred embodiments, the pressure application is wave-like or sequential. Sequential compression is produced by applying pressure distally first and proximally later, thereby generating a wave of compression that propagates toward the heart and is retrograde with respect to normal arterial blood flow in the patient. The speed of the compression wave is preferably comparable to the speed of wave propagation through the peripheral arteries. Preferably, the speed of the wave is from about 1 m/s to about 15 m/s, more preferably from about 5 m/s to about 10 m/s.

In yet other preferred embodiments, the pressure application is both graded and sequential.

In certain preferred embodiments, the pressure exerted by the apparatus increases and decreases as rapidly as possible to allow for the greatest degree of emptying and filling of the compressed vessels. Preferably, the inflation and deflation periods are from about one-hundredth of a second to about one second, more preferably from about 0 sec to about 0.5 second.

In certain preferred embodiments the external compression of the body part(s) is optimized for the purpose of maximizing the stimulus to the arterial endothelium of the peripheral arteries and thereby induce the secretion of angiogenic factors. Others have attempted to optimize external compression based on the notion that this can produce a reduction in systolic afterload or diastolic augmentation. If one wishes to treat a patient with coronary artery disease through angiogenesis, the external compression applied would preferably be optimized to lead to a change in shear stress in the arteries of the coronary circulation, aortic root, or the lower extremities. Such parameters that need to be considered in optimizing the external compression for the stimulation of angiogenic factors include, but are not limited to, maximum pressure, timing, method of applying pressure (e.g., graded, sequential, etc.)

In other preferred embodiments, the external compression is optimized to stimulate the largest area of endothelial cells. For example, compressions may not only stimulate the vessels actually being compressed but may also affect those upstream such as the aorta and those downstream such as the arterioles and capillary bed.

In certain particularly preferred embodiments, the pattern of pressure application is timed with the cardiac cycle. Preferably, pressure application is antiphase to left ventricle systole (i.e., external pressure is applied during diastole). Timing the pressure application with the heart in this manner does not lead to stress on the heart and may lead to augmentation of blood flow and a reduction in cardiac afterload. In one particularly preferred embodiment, compression and decompression is synchronized with the patient's electrocardiogram (ECG). For example, the compression period may begin at the end of the T-wave of the EKG signal and may end at the R-wave. For a more detailed discussion of inflating and deflating a balloon based on an ECG signal, please see U.S. Pat. Nos. 3,707,960 and 4,692,148, each of which is incorporated herein by reference.

The external compression leads to a change in the environment of the cells in the blood vessels due to the effect of the compression on various hemodynamic forces. Cells that may be affected by the compression include, but are not limited to, endothelial cells, fibroblasts, muscle cells, smooth muscle cells, blood cells (e.g., leukocytes, platelets), and epithelial cells. The cells respond to the change in their environment by producing various factors including angiogenesis factors, platelet-derived growth factor, fibroblast-derived growth factor, epidermal growth factor, vascular endothelial-derived growth factor, mitogens, prostaglandins, nitric oxide (NO), leukotrienes, and cytokines. Some of these factors such as NO may only act locally where they are produced due to their short half-lives. Others such as the growth factors may be transported in the blood to other locations and affect distant cells. The affected cells will preferably have receptors for the growth factor. In a particularly preferred embodiment, the cells of the affected area with reduced blood flow or suffering from injury will have receptors for these factors made elsewhere in the body and induced by external compression.

The external compression method may be applied to a patient periodically, continuously, or only once. Preferably, the method is applied to a patient numerous times at set intervals until blood flow is restored, wound healing occurs, or symptoms are decreased. For example, external compression may be applied to a patient suffering from peripheral vascular disease 1-5 times a day for one half hour each time over 3-6 weeks in order to promote the growth of new blood vessels in the low extremities. The inventive method may also be used prophylactically. For example, a diabetic patient at risk for peripheral vascular disease may be treated with external compression to reduce the chances of later developing peripheral vascular disease and the complications thereof. The regimen to be followed may be determined by one of skill in the art by taking into consideration such factors as the desired endpoint, the severity of the reduced blood flow or wound, the patient's initial response to the treatment, the patient's wishes, the patient's overall condition, etc. As with any medical treatment, it would be appreciated by one of skill in this art that a patient's treatment regimen should preferably be tailored to each individual treated.

In another particularly preferred embodiment of the present invention, in addition to or instead of a positive pressure being applied to a body part, a negative pressure with respect to atmospheric pressure is used in the inventive method. The apparatus for delivering the negative pressure would house a part of a patient's body substantially sealed off from the atmosphere so that a negative pressure reservoir such as a vacuum pump could be used to reduce the pressure inside the apparatus for a period of time. The apparatus may then be pressurized back up to atmospheric pressure or above atmospheric pressure. The pressurization/depressurization cycles may be timed to the cardiac cycle of the patient in much the same way as the compression method may be synchronized with the patient's cardiac rhythm. Negative pressure may be used, for example, to enhance refilling of collapsed arteries.

Apparatus

The present invention also provides an apparatus for carrying out the inventive method of external compression for inducing angiogenesis or wound healing. The apparatus comprises a source of liquid or gas, a compression structure for receiving the liquid or gas, and a control means for achieving inflation and deflation of the compression structure. The control means controls the flow of the gas or liquid into and/or out of the compression structure, thereby applying pressure to the body part to which the compression structure is attached.

The liquid or gas used to inflate the compression structure of inventive apparatus may be any gas or liquid. Preferred gases include, but are not limited to, air, nitrogen, argon, helium, carbon dioxide, and mixtures thereof. Preferred liquids include, but are not limited to, water, a buffered aqueous solution, a polymer solution, and an organic liquid.

The compression structure is a balloon or bladder capable of receiving the gas or liquid and exerting a pressure on the body part to which the compression structure is attached. In a particularly preferred embodiment, the compression structure is made of a polymer or plastic material. In a particularly preferred embodiment, the compression structure is capable of being distended without tearing or rupture. The compression structure is attached to the body part of the patient by Velcro® straps, zippers, elastic bands, buttons, snaps, etc. It will be appreciated by one of skill in this art that the dimensions and shape of the compression apparatus will depend on the patient to which it is being attached as well as on the body part to which the compression apparatus is being attached.

The compression structure may also be a band with variable tension. These bands may be wrapped around an extremity or around a patient's midsection. The tension in the bands may then be adjusted to provided the required external compression. The length and width of the band, as would be appreciated by one of skill in this art, will depend on the patient's size, the extremity to which it is applied, the amount of tension to be applied, etc. The bands may be continuous or the ends may be attached together using snaps, an adjustable fastener, buttons, Velcro®, zippers, etc. For an example of such a compression structure, please see U.S. Pat. No. 5,407,418, issued Apr. 18, 1995; incorporated herein by reference.

The control means controls the inflation of the compression structure by allowing the fluid or gas to flow into the compression structure. For example, in the case of a pressurized gas the control means may open a valve which allows the pressurized gas to flow into the compression structure. In another example, the control means may turn on a pump that delivers a gas or a liquid into the compression structure.

The apparatus may also comprise a means for accelerating the withdrawal of the liquid or gas from the compression structure (e.g., vacuum pump or a negative pressure reservoir). In a preferred embodiment, the control means controls the withdrawal means and thereby controls deflation of the compression structure. For example, the control means may open a valve connecting the vacuum pump with the compression structure to allow for the quick evacuation of the gas or liquid.

The apparatus may optionally comprise a blood oxygen detector, a pulse oximeter, an EKG detector, a blood pressure monitor, a heater, and/or a refrigeration unit The additional devices may be used to monitor the status of the patient, or they may be used to time the inflation and deflation of the compression structure. In a particularly preferred embodiment, the pulse oximeter, EKG detector, or blood pressure monitor is interfaced with the control means so that the control means can time the inflation and deflation of the compression structure to certain events in the cardiac cycle. For example, at the end of systole, the compression means inflates, and before systole begins, the compression means deflates.

In another preferred embodiment, instead of the compression structure being an inflatable bladder, the apparatus uses flexible bands, and the tension in the bands is used to apply external compression to the body part. The tension in the band is controlled by the control means and may be timed with the cardiac cycle as described above.

These and other aspects of the present invention will be further appreciated upon consideration of the following Examples, which are intended to illustrate certain particular embodiments of the invention but are not intended to limit its scope, as defined by the claims.

### EXAMPLES

### Example 1

### Numerical Simulation of Enhanced External Counterpulsation Introduction

Enhanced external counterpulsation (EECP) is a non-invasive, counterpulsative procedure providing temporary support for the failing heart. EECP involves surrounding the lower half of a patient's body (lower abdomen, thighs, and calves) with inflatable cuffs that are pressurized and depressurized approximately out-of-phase with the left ventricle. While the aortic valve is closed (ventricular diastole), pressurization of the cuffs collapses the arteries causing the blood stored in the lower extremities to be directed retrograde toward the heart. The resultant increase in aortic diastolic pressure has the potential to increase blood flow to vital organs, especially the heart, which receives much of its perfusion during diastole. Just prior to ventricular ejection (systole), the cuffs are depressurized to atmospheric pressure and the collapsed arteries begin to refill. This causes a rarefaction wave to propagate retrograde reaching the heart during cardiac systole, thereby decreasing cardiac afterload.

EECP has been tested as a means of cardiac assist in patients suffering from cardiogenic shock (Sorroff, H. S., Cloutier, C. T., Birtwell, W. C., Begley, L. A., Messer, J. V. External counterpulsation, management of cardiogenic shock after myocardial infarction. J. Am. Med. Assn. 229:14411450, 1974; incorporated herein by reference) and acute myocardial infarction (Parmley, W. W., Chatterjee, K., Charuzi, Y., Swan, H. U. Hemodynamic effects of noninvasive systolic unloading (nitroprusside) and diastolic augmentation (external counterpulsation) in patients with acute myocardial infarction. Am. J. Cardiol. 33:819-825, 1974; incorporated herein by reference), and as treatment for cardiac ischemia and angina (Lawson, W. E., Hui, J. C., Zheng, Z. S., Burgen, L., Jiang, L., Lillis, O., Oster, Z., Soroff, H., Cohn, P. improved exercise tolerance following enhanced external counterpulsation: cardiac or peripheral effect? Cardiology,. 87(4):271-275, 1996; Lawson, W. E., Hui, J. C., Soroff H. S., Zheng, Z., et al. Efficacy of enhanced external counterpulsation in the treatment of angina pectoris. American Journal of Cardiology, 70(9):859-862, 1992; each of which is incorporated herein by reference). Despite some success in these trials EECP is not currently used as a means of cardiac assist. It is, however, gaining acceptance as a treatment for patients suffering from cardiac ischemia and severe angina secondary to coronary disease (Amsterdam, E. A., Banas, J., Cartley, J. M., et al. Clinical assessment of external pressure circulatory assistance in acute myocardial infarction. Am. J. Cardiol., 45:349, 1990; Lawson, W. E., Hui, J. C., Soroff H. S., Zheng, Z., et al. Efficacy of enhanced external counterpulsation in the treatment of angina pectoris. American Journal of Cardiology, 70(9):859-862, 1992; Zheng, Z. S., Li, T. M., Kambic H., et al. Sequential external counterpulsation (SECP) in China. Transactions of the American Society of Artificial Internal Organs, 29:599-603, 1983; each of which is incorporated herein by reference) based on strongly favorable results from a recent multi-center study (Arora, R. R., Chou, T. M., Jain, D., Fleishman, B., Crawford, L., McKiernan, T., Nesto, R. W. The multicenter study of enhanced external counterpulsation (MUST-EECP): effect of EECP on exercise-induced myocardial ischemia and anginal episodes. J. Am. Col. Cardiol., 33(7):1833-1840, 1999; each of which is incorporated herein by reference).

Despite this success, the mechanisms by which EECP reduces angina and improves cardiac function remains unclear. It has been proposed that factors other than the purely mechanical ones may be responsible, and that EECP may enhance the development of collateral vessels in the coronary circulation. For example, Soran et al. recently argued that the beneficial effects of EECP might be a consequence of angiogenic factors released as a result of increased shear stress (Soran, A. U., Crawford, L. E., Schneider, V. M., and Feldman, A. M. Enhanced external counterpulsation in the management of patients with cardiovascular disease. Clinical Cardiology, 22(3): 173-178, 1999; incorporated herein by reference).

Here we extend that thesis, and propose that the vascular (endothelial and/or smooth muscle) cells of the lower extremity may be a source of these factors since the enhancement in shear stress is far more dramatic there than elsewhere in the circulation, and the endothelial surface area quite large. We therefore consider not only on the changes in aortic root pressure as it relates to direct, mechanical cardiac effects and coronary blood flow, but also arterial collapse and the augmentation of hemodynamic shear stress that accompany lower extremity compression. A new cardiovascular fluid mechanics model is presented that allows us to simulate the hemodynamics associated with EECP to determine how the operating parameters of the device influence its performance.

Methods

The Cardiovascular Model

Governing equations. Following Stettler et al. (Stettler, J. C., Niederer, P. and Anliker, M. Theoretical analysis of arterial hemodynamics including the influence of bifurcations. Part I: Mathematical Model and Prediction of Normal Pulse Patterns. Annals of Biomedical Engineering 9:145-164, 1981; incorporated herein by reference), we consider the one-dimensional form of the equations of motion since we are interested in the mean values of pressure and flow at specific locations in the arteries. Furthermore, higher dimensional flow problems are at present too computationally expensive to be of practical use. One-dimensional flow in an elastic artery can be described using the basic equations for momentum and continuity:

$$\begin{matrix}\frac{\partial }{\partial t} [ A ] + \frac{\partial }{\partial x} [ B ] + [ C ] = 0 \\ where & ( 1 ) \\ [ A ] = [ \begin{matrix}u \\ A\end{matrix} ] , [ B ] = [ \begin{matrix}{u}^{2} / 2 + P / ρ \\ u A\end{matrix} ] , and [ C ] = [ \begin{matrix}F \\ Ψ\end{matrix} ] & ( 2 ) , ( 3 ) , ( 4 )\end{matrix}$$

where u and P are the local cross-sectional average velocity and pressure, A is the cross-sectional area, and F is the frictional loss, to be described later in further detail. The term ψ representing minor branch flow in the continuity expression represents the distributed outflow per unit length and is approximated as a linearly resistive element, described by the equation

ψ(P,x)=Φ(x)(P−Pᵥ) (5)

Here the driving force for flow is the pressure drop between the local arterial pressure and the uniform venous pressure Pᵥ. The constant Φ(x) describes the spatial distribution of flow into smaller branches.

A pressure-area relation or “tube law” may be formulated to provide a third independent equation. This relationship will be described below. The set of hyperbolic, partial differential equations in Eq. (1) for the arterial elements are solved using an adaptation of the MacCormack two step predictor-corrector method (Anderson, D. A., Tannenhill, J. C., and Pletcher, R. H. Computational Fluid Mechanics and Heat Transfer. McGraw Hill, New York, 1984; incorporated herein by reference).

The expression for the frictional loss F in Eq. (4) may be derived as follows. The general form of the frictional or viscous loss term is given by the expression:

$$F = - \frac{2 {τ}_{o}}{ρ R} \qquad ( 6 )$$

where R is the arterial radius. From Young and Tsai (Young, D. F., Tsai, F. Y. Flow characteristics in models of arterial stenoses-II. Unsteady flow. J. Biomechanics 6: 547-559, 1973; incorporated herein by reference) the shear stress term may be represented as:

$${τ}_{o} = \frac{4 {C}_{v} μ}{R} \cdot u ( t ) + \frac{ρ}{2 π R} \cdot ( {C}_{u} - 1 ) \cdot \frac{\partial Q}{\partial t} \qquad ( 7 )$$

where Cᵤ and Cᵥ are functions of the local frequency parameter α:

$$α = {R}_{o} \cdot \sqrt{\frac{ω}{v}} \qquad ( 8 )$$

Here Rₒ is the arterial radius, ω is the angular frequency of oscillation, and υ is the kinematic viscosity of the fluid. Young and Tsai (Young, D. F., Tsai, F. Y. Flow characteristics in models of arterial stenoses-II. Unsteady flow. J. Biomechanics 6: 547-559, 1973; incorporated herein by reference) give plots of Cᵤ and Cᵥ versus α, from which algebraic approximations were generated for use in the model.

A hybrid tube law was used to describe the relationship between arterial cross-sectional area and transmural pressure. During arterial collapse, the steady state shear term in Eq. (7) is increased by a factor of three to reflect the change in cross-sectional shape (Kamm, R. D., and Shapiro, A. H. Unsteady flow in a collapsible tube subjected to external pressure or body forces. J. Fluid Mech. 95:1-78, 1979; incorporated herein by reference). We also modify the tube law used by Stettler et al. (Stettler, J. C., Niederer, P. and Anliker, M. Theoretical analysis of arterial hemodynamics including the influence of bifurcations. Part I: Mathematical Model and Prediction of Normal Pulse Patterns. Annals of Biomedical Engineering 9:145-164, 1981; incorporated herein by reference) to avoid a singularity that arises at negative transmural pressures. The modified forms are used when A/A₀<0.36 where Aₒ is the area at a reference pressure Pₒ=100 mmHg (13.3 kPa) and has the form:

$${P}_{t m} = {P}_{t m} ( A ) + η \frac{\partial A}{\partial t} \qquad ( 9 )$$

Here the transmural pressure Pₜₘ is the difference between the internal and external pressures across the artery wall and is related to the cross-sectional area through the expressions given in Table 1. The term Pₜₘ(A) in Eq. (9) represents the elastic response associated with a static transmural pressure, and η is a damping coefficient. A value of 2.0×10⁵ N s m⁻⁴ was used for η in the model, selected based on comparisons to a previous, somewhat more rigorous model for viscoelasticity (Holenstein, R., Niederer, P., Anliker, M. A viscoelastic model for use in predicting arterial pulse waves. J. Biomech. Eng., 102:318-324, 1980; incorporated herein by reference) as described in Bottom (Bottom, K. E. “A numerical model of cardiovascular fluid mechanics during exernal cardiac assist.” Thesis, S. M., Massachusetts Institute of Technology, May, 1999; incorporated herein by reference). The actual form of the tube law expressing area as a function of pressure is solved using a binomial expansion approximation applied to Eq. (9). The equations required for calculation of the hybrid tube law are summarized in Table 1 for both the collapsed and uncollapsed regimes.

TABLE 1
Forms used to describe the elastic response of the artery in the numerical solution.
Different forms were required to capture the behavior of the distended
(A · A_{T}) and collapsed (A < A_{T}) vessels.

| | | |
|---|---|---|
| Inverse tube law | A · A_{T} | ${P}_{tm} = [ \frac{{P}_{0} + ρ {c}_{0} g ( z ) {χ}_{0} ln ( \frac{A}{{A}_{0}} )}{1 - ρ {c}_{0} Bg ( z ) ln ( \frac{A}{{A}_{0}} )} ] + η \frac{\partial A}{\partial t}$ |
| | A < A_{T} | ${P}_{tm} = {P}_{0} + ρ {c}_{0} g ( z ) ( {χ}_{0} + {BP}_{T} ) ln ( \frac{A}{{A}_{0}} ) + η \frac{\partial A}{\partial t}$ |
| Elastic response | A · A_{T} | ${A}^{s} = {A}_{0} exp [ \frac{{P}_{tm} - {P}_{0}}{ρ {c}_{0} c ( P , z )} ]$ |
| | A < A_{T} | ${A}^{s} = {A}_{0} exp [ \frac{{P}_{tm} - {P}_{0}}{ρ {c}_{0} g ( z ) ( {χ}_{0} + {BP}_{T} )} ]$ |
| Wave speed | A · A_{T} | c(P, z) = g(z)(χ₀ + BPₜₘ) |
| | A < A_{T} | $c ( P , z ) = \sqrt{g ( z ) {c}_{0} ( {χ}_{0} + {BP}_{T} )}$ |

Notes:
Condition for collapse is A < A_{T}, where A is the cross-sectional area, and A_{T} is the transitional area, A_{T} = 0.36A₀.
Pₜₘ is the transmural pressure.
Pₒ is the reference pressure, equal to 100 mmHg (13.3 kPa).
Aₒ is the elastic response at the reference pressure Pₒ.
The constants B, χₒ, and the function g(z) are obtained from experimental measurements as described in Stettler et al. (Stettler, J.C., Niederer, P. and Anliker, M. Theoretical analysis of arterial hemodynamics including the influence of bifurcations. Part I: Mathematical Model and Prediction of Normal Pulse Patterns. Annals of Biomedical Engineering 9:145-164, 1981; incorporated herein by reference).

Bifurcations. The individual arterial segments are coupled through appropriate boundary conditions. At bifurcations where a single tube branching into separate daughter tubes we write the equation of energy conservation for a control volume corresponding to a stream tube that includes all of the flow entering the nth daughter branch (Wolf, T. “An Experimental/Theoretical Investigation of Parallel Inhomogeneities in Respiratory Flows.” Ph.D. thesis, Dept. of Mechanical Engineering, Massachusetts Institute of Technology: June, 1990; incorporated herein by reference):

$$ρ \frac{\partial {u}_{1}}{\partial t} {x}_{1} + ρ \frac{\partial {u}_{n}}{\partial t} {x}_{n} + {P}_{n} + \frac{1}{2} ρ ( {u}_{n}^{2} {f}_{n} + {u}_{n} \vert {u}_{n} \vert {k}_{n} ) - {P}_{1} - \frac{1}{2} ρ {u}_{1}^{2} + \frac{1}{2} ρ {u}_{n} \vert {u}_{1} {u}_{n} {\vert}^{1 / 2} {λ}_{n} = 0 \qquad ( 10 )$$

where the subscript “1” denotes the parent branch and the subscript “n”, one of the daughter branches. The absolute values of velocity are incorporated to preserve the directionality of the losses as the flow changes direction. The unsteady continuity equation for the control volume encompassing the entire bifurcation including all daughter vessels is written as:

$$\frac{\partial {A}_{1}}{\partial t} {x}_{1} + \frac{\partial {A}_{2}}{\partial t} {x}_{2} + … + \frac{\partial {A}_{N}}{\partial t} {x}_{N} - {u}_{1} {A}_{1} + {u}_{2} {A}_{2} + … + {u}_{N} {A}_{N} = 0 \qquad ( 11 )$$

where N is the total number of elements connected at a bifurcation, including the parent branch. The equations of motion are coupled with momentum, continuity and the hybrid tube law are applied at the interface between an element and the bifurcation control volume.

The term ƒₙ in Eq. (10) representing the ratio of actual kinetic energy flux at n to that corresponding to a flat velocity profile is assumed to approach unity in the parent branch. The coefficients λₙ and kₙ are dimensionless head loss coefficients due to “entrance type” and “turbulent type” losses, respectively. Following Pedley et al. (Pedley, T. J., Schroter, R. C. and Sudlow, M. F. Energy losses and pressure drop in models of human airways. Resp. Physiol. 9:371-386, 1970), λₙ is given by:

$${λ}_{n} = {\frac{16 C}{\sqrt{2}} [ \frac{1}{{Re}_{1}} \frac{{D}_{1}}{{D}_{n}} \frac{{L}_{n}}{{D}_{n}} ]}^{1 / 2} \qquad ( 12 )$$

where Re₁ is the Reynolds number of the parent branch, C is a constant, D₁ and Dₙ are the diameters for the parent branch and nth daughter branch respectively, and Lₙ is the entrance length for the nth daughter branch.

Values of the kinetic energy and dissipation factors are dependent on the nature of flow at the bifurcation. These loss coefficients are approximated by Wolf (Wolf, T. “An Experimental/Theoretical Investigation of Parallel Inhomogeneities in Respiratory Flows.” Ph.D. thesis, Dept. of Mechanical Engineering, Massachusetts Institute of Technology: June, 1990; incorporated herein by reference) as:

$${k}_{n} = {( 1 - \frac{1}{{K}_{c , n}} )}^{2} and {f}_{n} = {( \frac{1}{{K}_{c , n}} )}^{2} \qquad ( 13 ) , ( 14 )$$

The contraction coefficient K_{c,n} represents the ratio between the minimum normal cross-sectional area of the streamtube within the separated region of the nth daughter branch, and the area of the branch itself. Hence, for smaller angles between adjacent daughter branches, separation does not occur and K_{c,n} should approach unity. Using literature values for the anatomical branching angles of the arterial system, a linear relationship between angle and K_{c,n} is assumed and values assigned for each branch. The method is imprecise, however a sensitivity analysis of the contraction coefficients demonstrates that exact values are not required due to their small effect on the system as a whole. The energy conservation equation [Eq. (10)], and the unsteady form of continuity [Eq. (11)] are solved by the MacCormack predictor-corrector computational scheme (Amsterdam, E. A., Banas, J., Cartley, J. M., et al. Clinical assessment of external pressure circulatory assistance in acute myocardial infarction. Am. J. Cardiol., 45:349, 1990; incorporated herein by reference), coupling the state variables of the bifurcation end-nodes with the internal points of the involved arterial elements.

Ventricle. A model of the left ventricle acts as an upstream boundary for the arterial tree. The ventricle may be approximated as a chamber whose compliance (or the inverse of elastance) changes with time, thus driving flow through a unidirectional exit valve into the aorta. Following the work of Suga and Sagawa (Suga, H. and Sagawa, K. Instantaneous pressure-volume relationships and their ratio in the excised, supported canine left ventricle. Circulation Research, 35, 1974; incorporated herein by reference), the specified elastance curve E(t) is used to characterize ventricular ejection and filling. Extensive studies of the pressure-volume relationship in canine ventricles (Suga, H. and Sagawa, K. Instantaneous pressure-volume relationships and their ratio in the excised, supported canine left ventricle. Circulation Research, 35, 1974; incorporated herein by reference) have shown that the basic shape of the systolic portion of the pressure-volume curve remains unchanged, regardless of loading or wall compliance changes. Thus, the systolic wall elastance may be characterized by only two parameters; the peak wall elastance, Eₘₐₓ, and time to this peak elastance during one cycle, Tₘₐₓ. The duration of the cycle is extrapolated from Suga and Sagawa's data suggesting that Tₘₐₓ spans approximately 30-50% of the total cycle.

In a later extension of this model by Suga and Sagawa (Suga, H., Sagawa, K., Demer, L. Determinants of Instantaneous Pressure in Canine Left Ventricle: Time and Volume Specification. Circ. Res. 46: 256-263, 1980; incorporated herein by reference), the effects of myocardial viscoelasticity were taken into account by the addition of one term to the ventricular pressure-volume relation. We found this approach to better fit data for humans (Ozawa, E. T. “A numerical model of the cardiovascular system for clinical assessment of the hemodynamic state.” Thesis, Ph.D., Massachusetts Institute of Technology, September, 1996; incorporated herein by reference) and have consequently used the following form in the present simulations:

$${P}_{vent} = {E}^{⨯} ( t ) \cdot ( {V}_{vent} - {V}_{vent , 0} ) \cdot [ 1 + σ ( \frac{ⅆ {V}_{vent}}{ⅆ t} ) ] + {P}_{tp} \qquad ( 15 )$$

The coefficient Υ is a scaling factor for the time-dependent viscoelastic effects, Pᵥₑₙₜ is the ventricular volume, Vᵥₑₙₜ is ventricular volume, V_{vent,o} is the zero-pressure filling volume, and Pₜₚ is the transpulmonary pressure in the chest cavity which is expected to alter the left ventricular transmural pressure. We define the isovolumetric contraction curve E*(t) and assume it to be a half sinusoid, whose duration and amplitude can be modified to represent different compliances and heart rates. Thus, the ventricular pressure may be solved for, given that the flowrate at the root of the aorta is equal to the time derivative of ventricular volume.

Sinuses of Valsalva. As flow begins to reverse, the valve leaflets are swept backwards and close without sustaining a significant pressure gradient. Filling of the sinuses continues until the valve leaflets are maximally distended, at which time the leaflets are able to sustain a pressure gradient. This may be modeled as an abrupt decrease in the aortic root compliance to a new value, Cₛᵢₙᵤₛ, as well as imposing a zero-flow boundary condition at the first node. This condition is held until the ventricular pressure again exceeds aortic pressure.

Terminal branch points. The numerical model described here uses linear segments to represent the larger vessels in the main arterial tree, but modeling the finer branching structure approaching the arterioles in this manner is impractical. Rather, the terminal vessels are modeled as a lumped parameter Windkessel (Berger, D. S., Li, J. K-J, and Noordergraf, A. Arterial Wave Propagation Phenomena, Ventricular Work, and Power Dissipation. Ann. Biome.l Eng. 23:804-811, 1995; Berger, D. S., Li, J. K-J, and Noordergraf, A. Differential effects of wave reflections and peripheral resistance on aortic blood pressure: a model-based study. Am. J. Physiol. 266: (Heart Circ. Physiol.) 35:H1626-H1642, 1994; each of which is incorporated herein by reference). The model allows the behavior of the small arterial vessel beds to be captured using only a few parameters and accurately mimics peripheral wave reflections (Ozawa, E. T. “A numerical model of the cardiovascular system for clinical assessment of the hemodynamic state.” Thesis, Ph.D., Massachusetts Institute of Technology, September, 1996; incorporated herein by reference). The Windkessel consists of a resistance Rₛ in parallel with a compliance Cₛ, where the resistance represents the pressure drop associated with the terminal arterioles, and the compliance represents the total compliance of the small artery network. In series upstream from the Windkessel is an additional element Zₒ, which represents the entrance impedance of the small arterial bed with an associated pressure drop of P−P_{c}, where P is the pressure at the last node in the terminating arterial segment, and P_{c} is the capillary bed pressure. This impedance is matched to that of the adjoining element to avoid the generation of reflections resulting from an impedance mismatch at this interface. Thus, Zₒ, is approximated as ρc/A using the wavespeed and area for the element node bordering the Windkessel. From the electrical analogue, the following equations may be written as a function of the resistances and capacitances:

$$\begin{matrix}\frac{{P}_{c} - {P}_{y}}{{R}_{s}} + {C}_{s} \frac{ⅆ {P}_{tm}}{ⅆ t} = Q & ( 16 ) \\ Q = \frac{1}{{Z}_{o}} ( P - {P}_{c} ) & ( 17 )\end{matrix}$$

where Q is flow entering the Windkessel, Pᵥ is the venous pressure, and Pₜₘ=P_{c}−Pₑ is the transmural pressure, where the external pressure Pₑ may be specified. The Windkessel is coupled numerically to its upstream element in this model using the method of characteristics.

Within the region of external compression the externally applied pressure is used as the reference pressure for the capacitor in the windkessel model. Venous pressure is assumed constant for the purpose of these calculations. Consequently, the dynamics occurring on the venous side of the circulation, while potentially important, are not considered in the present calculations. The implications of this assumption are discussed later.

The model, as implemented for these simulations, is operated in “open mode” in that the venous and pulmonary circulations have been omitted. In so doing, the dynamics of the venous bed associated with EECP are essentially ignored on the assumption that the changes in mean venous pressure due to EECP will have minimal effect on the pulsatile flows and pressures on the arterial side. Variations of venous pressure in the region of compression may have a somewhat greater effect as discussed below.

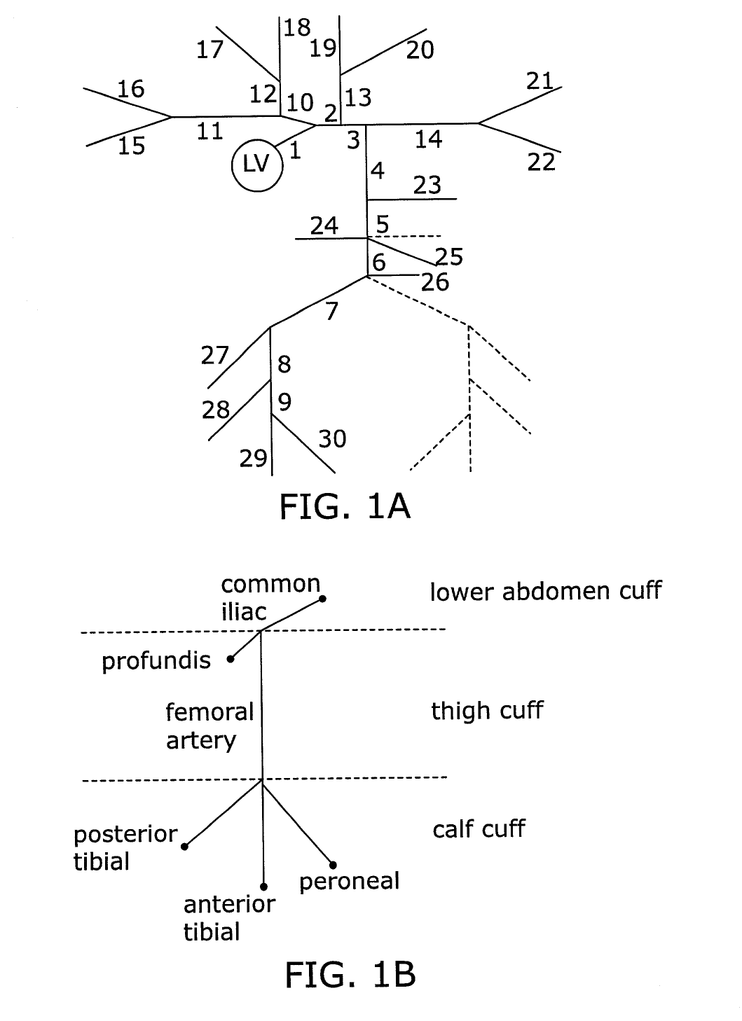

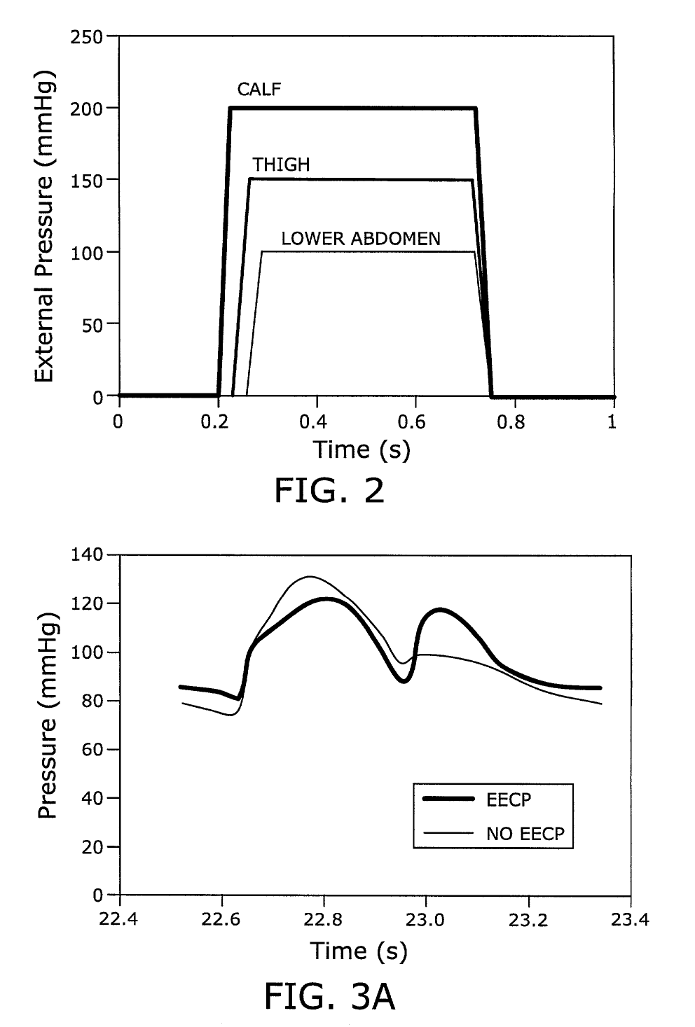

Parameter Specification. Information on cardiovascular system parameters exists, but the data are highly variable and extremely dependent on the state (e.g. posture) of the individual or animal at the time when measurements are taken. Nonetheless, a standard case that produces a reasonable model output for a given set of parameters is required. Avolio (Avolio, A. P. Multi-branched model of the human arterial system. Med. Biol. Eng. Comput. 18:709-18, 1980; incorporated herein by reference) presents an extensive list of arterial lengths, diameters, wall thicknesses, and Young's moduli for most of the major human arteries (a sum total of 128). For the present model, 30 elements are used. This network is shown schematically in FIG. 1. The numbered elements correspond to major arteries whose properties are provided in Table 2.

TABLE 2
Specifications for the 30 element model: arterial
properties. Proximal and distal cross-sectional
areas are given, and it is assumed that area varies
linearly with distance along the vessel. E is the
Young's modulus of the vessel wall.

| | | | proximal | distal | |
|---|---|---|---|---|---|
| | | length | area | area | E × 10⁵ |
| element # | artery name | (m) | (x10⁻⁴m²) | (x10⁻⁴m²) | (Pa) |
| 1 | ascending aorta | 0.055 | 6.605 | 3.941 | 4.0 |
| 2 | aortic arch | 0.02 | 3.90 | 3.90 | 4.0 |
| 3 | aortic arch | 0.02 | 3.80 | 3.80 | 4.0 |
| 4 | thoracic aorta | 0.185 | 3.597 | 2.835 | 4.0 |
| 5 | abdominal aorta | 0.043 | 2.378 | 2.378 | 4.0 |
| 6 | abdominal aorta | 0.096 | 1.021 | 1.021 | 4.0 |
| 7 | common iliac | 0.192 | 0.849 | 0.229 | 4.0 |
| 8 | femoral artery | 0.432 | 0.181 | 0.126 | 8.0 |
| 9 | anterior tibial | 0.015 | 0.053 | 0.053 | 16.0 |
| | artery | | | | |
| 10 | brachiocephalic | 0.024 | 1.208 | 1.208 | 4.0 |
| 11 | r brachial | 0.410 | 0.503 | 0.181 | 4.0 |
| 12 | r conmon carotid | 0.168 | 0.503 | 0.503 | 4.0 |
| 13 | l common carotid | 0.110 | 0.503 | 0.503 | 4.0 |
| 14 | l brachial | 0.444 | 0.554 | 0.181 | 4.0 |
| 15 | r radial | 0.229 | 0.08 | 0.08 | 8.0 |
| 16 | r ulnar | 0.232 | 0.139 | 0.113 | 8.0 |
| 17 | r external carotid | 0.113 | 0.196 | 0.071 | 8.0 |
| 18 | r internal carotid | 0.172 | 0.283 | 0.053 | 8.0 |
| 19 | l internal carotid | 0.172 | 0.283 | 0.053 | 8.0 |
| 20 | l external carotid | 0.113 | 0.196 | 0.071 | 8.0 |
| 21 | l radial | 0.229 | 0.08 | 0.08 | 8.0 |
| 22 | l ulnar | 0.232 | 0.139 | 0.113 | 8.0 |
| 23 | coeliac | 0.010 | 0.478 | 0.478 | 4.0 |
| 24 | renal | 0.027 | 0.212 | 0.212 | 4.0 |
| 25 | sup mesenteric | 0.054 | 0.581 | 0.581 | 4.0 |
| 26 | inf mesenteric | 0.045 | 0.08 | 0.08 | 4.0 |
| 27 | profundis | 0.121 | 0.166 | 0.166 | 16.0 |
| 28 | post tibial | 0.306 | 0.102 | 0.102 | 16.0 |
| 29 | ant tibial | 0.295 | 0.031 | 0.031 | 16.0 |
| 30 | peroneal | 0.313 | 0.053 | 0.053 | 16.0 |

Arterial elements were specified in the model by a proximal and distal internal radius, from which the cross-sectional areas were calculated. The area was assumed to be a linear function of length between bifurcations. All elements were discretized into nodes, separated by a spatial increment, nominally 0.01 m. The branching pattern of the arteries was also taken from the arterial tree layout given by Avolio (Avolio, A. P. Multi-branched model of the human arterial system. Med. Biol. Eng. Comput. 18:709-18, 1980; incorporated herein by reference). In addition to geometrical measurements, the elasticity of each artery segment is specified in order to calculate the nominal reference wavespeed c₀ for each element, using the Moens-Korteweg equation:

$${c}_{0} = \sqrt{\frac{E h}{2 ρ R}} \qquad ( 18 )$$

Here, c₀ depends locally upon Young's modulus E, inner radius R, fluid density ρ and wall thickness h. Both R and h were assumed known with the internal static reference pressure P₀ equal to 100 mm Hg (13.3 kPa). Assuming a linear relationship between wall thickness and vessel radius, the model calculates cₒ at each node given dimensions and material properties. Values for Young's modulus (Table 2) were also obtained from Avolio's original data.

Local regulation of flow is extremely transient and dependent on a variety of factors, complicating the task of defining a “standard” distribution of flow. An alternative approach used in this model is based on the observation that the caliber of a vessel is related to the flow rate it conveys. This was first proposed by Murray in 1926 and later shown to result from biological factors that tend to maintain a constant wall shear stress in all arteries (Kamiya, A., Bukhari, R., and Togawa, T. Adaptive regulation of wall shear stress optimizing vascular tree function. Bull. Math. Biol. 46: 127-137, 1984; incorporated herein by reference). Thus, assuming a blood viscosity of 4.0×10⁻⁵ kg m⁻¹ s⁻¹, and a mean wall shear stress of 1.5 N m⁻² at a mean arterial pressure of 13.3 kPa (100 mm Hg), the required flow can be calculated for each node within the network. The difference in flow between nodes is assumed due Eq. (4). From the calculated required flow at each distal boundary node, the appropriate value of the terminal Windkessel resistance Rₛ is determined for each terminal element. This method provides values of mean flowrate that are in reasonable agreement with known physiological values. Where the predicted values differ from literature values, adjustments have been made. Values of other hemodynamic parameters are shown in Table 3.

TABLE 3
External Pressurization Input Control Parameters. All times referenced to the
beginning of cardiac systole.

| | | Baseline | |
|---|---|---|---|
| Parameter | Description | Values | |
| T_{infl} | Time from onset of cardiac cycle at which pressure starts | 0.20 | s |
| | to rise | | |
| T_{defl} | Time to begin deflation of cuffs from maximum external | 0.72 | s |
| | pressure | | |
| T_{card} | Period of cardiac cycle | 0.86 | s |
| P_{calf} | Maximum external pressure applied to calf vessels | 200 | mmHg |
| Pₜₕ | Maximum external pressure applied to thigh vessels | 150 | mmHg |
| Pₗₐ | Maximum external pressure applied to lower abdomen | 100 | mmHg |
| | vessels | | |
| Δt_{seg} | Time interval between inflations of adjacent cuff regions | 0.03 | s |
| | with the proximal region always pressurized first | | |
| tᵣₐₘₚ | Time it takes pressure to rise to and fall from its maximum | 0.03 | s |
| | value | | |
| ΔP_{seg} | Pressure difference between cuffs (pressure always | 50 | mmHg |
| | increasing in the direction of the foot) | | |
| Pₘ | Average applied pressure in the three cuff regions | 150 | mmHg |

A base state was chosen, typical of conditions used clinically, from which the effects of various parameter variations could be studied. All data presented are taken from the tenth heart cycle of the model to ensure that the simulation has reached a steady state. A heart rate of 72 beats/min is used for all simulations. Values of the control parameters used for this base state are given in Table 3. Some judgment was exercised in parameter selection. A second set of parameter values, with peak ventricular contractility reduced from 6000 to 1000 dyn/cm⁵, systemic vascular resistance increased from 1000 to 2666 dyn/cm⁵ and end diastolic volume increased from 120 to 280 ml was used to simulate a patient with compromised ventricular function. Validation of the model with normal parameters included comparisons to measured waveforms at various locations in the arterial system and measured arterial input impedance. Comparisons were also made to pressure and velocity traces found in the literature, but since these vary considerably among individuals direct comparisons are of limited value. These can be found in Ozawa (Ozawa, E. T. “A numerical model of the cardiovascular system for clinical assessment of the hemodynamic state.” Thesis, Ph.D., Massachusetts Institute of Technology, September, 1996; incorporated herein by reference).

External Pressurization Scheme. A three-step graded-sequential compression procedure was employed in all the simulations presented here. In sequential compression, a wave of compression is applied to the vessels by inflating the three pressurization cuffs for the calves, thighs, and lower abdomen sequentially from ankle to groin. The pressure level applied by the cuffs decreases from calf to thigh, and from thigh to lower abdomen cuffs. In contrast to the emptying behavior characteristic of uniform compression, sequential compression produces a collapse in the vessels that proceeds from the foot toward the heart. Thus, the blood is effectively “milked” from the vessels in the lower extremities and does not pass through a constrictive throat as in uniform compression (Lueptow, R. M., Karlen, J. M., Kamm, R. D., Shapiro, A. H. Circulatory Model Studies of External Cardiac Assist by Counterpulsation. Cardiovascular Research, 15(8):443-455, 1981; incorporated herein by reference). In graded compression the maximum level of pressure attained in each segment is greatest in the periphery and falls in the direction of the heart. The application of graded compression also helps to eliminate the occlusive throat and, in combination with sequential pressure application, produces rapid and complete emptying of the vessels (Lueptow, R. M., Karlen, J. M., Kamm, R. D., Shapiro, A. H. Circulatory Model Studies of External Cardiac Assist by Counterpulsation. Cardiovascular Research, 15(8):443-455, 1981; Zheng, Z. S., Li, T. M., Kambic H., et al. Sequential external counterpulsation (SECP) in China. Transactions of the American Society of Artificial Internal Organs, 29:599-603, 1983; each of which is incorporated herein by reference).

The cuffs used to provide pressurization of the lower extremities in EECP are modeled as external pressure sources on the lower abdomen, thigh, and calf arteries. To simulate graded-sequential compression in the model, the arterial tree elements for the lower body are divided into three regions, shown in FIG. 1, representing the areas covered by the three pressurization cuffs in EECP.

External Pressurization Control Parameters. Clinical and computational studies have shown the efficacy of EECP depends upon the mode of operation and parameter values used to control the device (Bai, J., Wu, D., Zhang, J. A Simulation Study of External Counterpulsation. Comput. Biol. Med.,. 24(2): 145-156, 1994; incorporated herein by reference). These parameters include the cuff inflation and deflation timings, the maximum pressure level applied externally to the vessels by each cuff, and the time delay of pressurization and depressurization between the calf, thigh, and lower abdomen cuffs for sequential compression. Table 3 shows a detailed description of the individual input control parameters governing external pressurization in the model.

In clinical practice, the application of external pressure during EECP is timed with the patient's electrocardiogram. In the EECP model, this process is accomplished by adjusting the timing of applied external pressure in each of the three compartments relative to left ventricular contraction, as characterized by E(t). For graded-sequential compression, the pressure in each cuff rises linearly to its maximum value over a timeₜᵣₐₘₚ, is held constant until a time T_{defl}, and then falls linearly over a time tᵣₐₘₚ. The calf, thigh, and lower abdomen cuffs are inflated at times T_{infl}, T_{infl}+Δt_{seg}, and T_{infl}+2Δt_{seg}, respectively. The maximum applied pressure is decreased between the calf and thigh cuffs and the thigh and lower abdomen cuffs as specified by P_{calf}, Pₜₕ, and Pₗₐ. The cuff deflation time, T_{defl}, is the same for all three cuffs to simplify the parameter study. The parameters used in the temporal application of external pressure during the heart cycle are given in Table 3. For all other parameter values, see Ozawa (Ozawa, E. T. “A numerical model of the cardiovascular system for clinical assessment of the hemodynamic state.” Thesis, Ph.D., Massachusetts Institute of Technology, September, 1996; incorporated herein by reference).

Mean applied pressure was chosen at a level thought to produce minimum trauma to the patient while still providing a reasonable measure of benefit. The pressure increment between segments was viewed as sufficient to prevent proximal arterial collapse and a consequent impairment of vessel emptying while still providing ample pressure at the lower abdomen region to produce significant emptying. Consistent with the notion that arterial emptying should proceed at a speed comparable to the speed of the arterial pressure pulse (about 8 m/s in the peripheral arteries), the time delay between segment compressions was chosen to be approximately equal to the wave transit time through each of the pressurized compartments. Pressure rise time, as shown by Bai et al., should be as short as possible (Bai, J., Ying, K., Jaron, D. Cardiovascular responses to external counterpulsation: a computer simulation. Med. Biol. Eng. Comput., 30:317-323, 1992; incorporated herein by reference). Therefore, a value was chosen close to the practical lower limit.

External Pressurization Measures of Merit. The effectiveness of enhanced external counterpulsation is assessed in terms of the following measures of merit:

Mean Diastolic Pressure. The increase in diastolic pressure, or diastolic augmentation, is characterized by the mean diastolic pressure ratio:

$$M D P = \frac{{[ \frac{1}{{T}_{D} - {T}_{S}} {{\int }_{{T}_{S}}}^{{T}_{D}} {P}_{aortic} ⅆ t ]}_{compr} - {[ \frac{1}{{T}_{D} - {T}_{S}} {{\int }_{{T}_{S}}}^{{T}_{D}} {P}_{aortic} ⅆ t ]}_{0}}{{[ \frac{1}{{T}_{D} - {T}_{S}} {{\int }_{{T}_{S}}}^{{T}_{D}} {P}_{aortic} ⅆ t ]}_{0}} \qquad ( 19 )$$

where P_{aortic} is pressure at the aortic root, T_{D} and T_{S} are the times at which diastole and systole end, and the subscripts “compr” and “0” refer to cases with and without external compression, respectively MDP is an indication of how diastolic pressure is increased with pressurization. All pressures are measured when the model has reached steady-state after 10 heart cycles.

Mean Systolic Pressure. The effect of EECP on systolic pressure is quantified using the mean systolic pressure ratio:

$$M S P = \frac{{[ \frac{1}{{T}_{S}} {{\int }_{0}}^{{T}_{S}} {P}_{aortic} ⅆ t ]}_{0} - {[ \frac{1}{{T}_{S}} {{\int }_{0}}^{{T}_{S}} {P}_{aortic} ⅆ t ]}_{compr}}{{[ \frac{1}{{T}_{S}} {{\int }_{0}}^{{T}_{S}} {P}_{aortic} ⅆ t ]}_{0}} \qquad ( 20 )$$

MSP is a measure of the extent of left ventricular afterload reduction with pressurization.

Emptying Effectiveness. The blood volume emptied from the leg vessels enters the aorta, and hence determines the amount of diastolic augmentation achieved by EECP. It also provides a measure of the extent to which arterial diameter changes, and therefore relates to vessel wall strain. The emptying effectiveness parameter, EE, is used to measure the efficiency of the emptying process for the vessels receiving pressurization. EE is calculated for a single vessel using the equation:

$$E E = \frac{{[ \int A \cdot ⅆ x ]}_{0} - {[ \int A \cdot ⅆ x ]}_{compr}}{{[ \int A \cdot ⅆ x ]}_{0}} \qquad ( 21 )$$

where A is the cross-sectional area of the artery. The integrations are taken over the entire region of pressurization for the artery of interest. For the “compr” case, arterial area is measured at maximum pressurization in diastole just prior to cuff deflation. The arterial area for case “0” is measured at the time step just preceding pressurization. Thus, the emptying effectiveness of the artery represents the extent of arterial collapse under maximum pressurization with respect to the state of the artery just prior to pressurization. The state of the artery prior to pressurization is considered since the artery may be partially collapsed if there has not been sufficient time for it to completely refill.

Shear Stress Index. An approximate measure of shear stress is defined, that accounts for the changes in cross-sectional area and flow velocity that accompany EECP. In the case of steady, fully-developed, laminar flow through a vessel of circular cross-section, wall shear stress could be computed as follows:

$${τ}_{w} = μ 4 \frac{\overline{V}}{\sqrt{A / π}} \qquad ( 22 )$$

where \overline{V} is the mean flow velocity. Recognizing that as an artery collapses, its cross-section will likely deviate from circular, and that the flow is clearly not fully-developed nor steady, we will still assume to a rough approximation that

$${τ}_{w} ∝ μ \frac{\overline{V}}{\sqrt{A}} \qquad ( 23 )$$

Actual values of shear stress will be larger than this due to the change in vessel shape and unsteadiness. However, as these effects are difficult to estimate accurately without resorting to fully three-dimensional calculations, we have chosen instead to use eq. (23) for the purpose of estimating the relative values of shear stress between simulations with and without EECP. Accordingly, a shear index, S, is defined as

$$S = \frac{{\sum }_{n = 1}^{3} {\overline{τ}}_{w , compr} - {\sum }_{n = 1}^{3} {\overline{τ}}_{w , 0}}{{\sum }_{n = 1}^{3} {\overline{τ}}_{w , 0}} \qquad ( 24 )$$

where \overline{τ}_{w,compr} is the time integral of the wall shear stress for one cycle evaluated at the mid-point of the compression zone and \overline{τ}_{w,0} is the same value with no external pressurization. The summation sign indicates that the values of \overline{τ}_{w,compr} and \overline{τ}_{w,0} are summed over the three compression zones.

Results

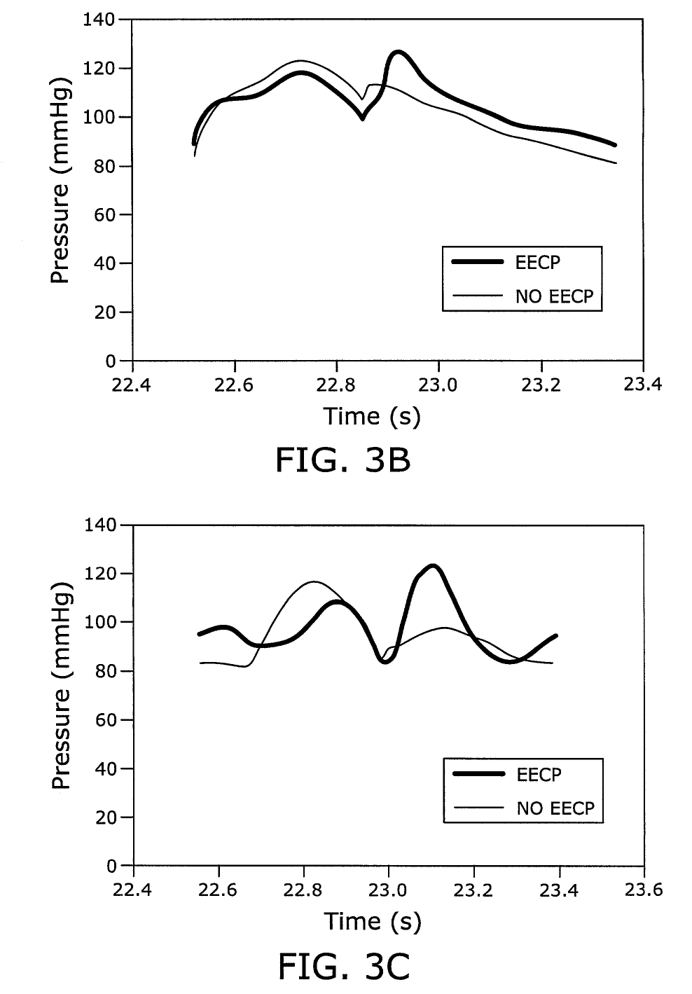

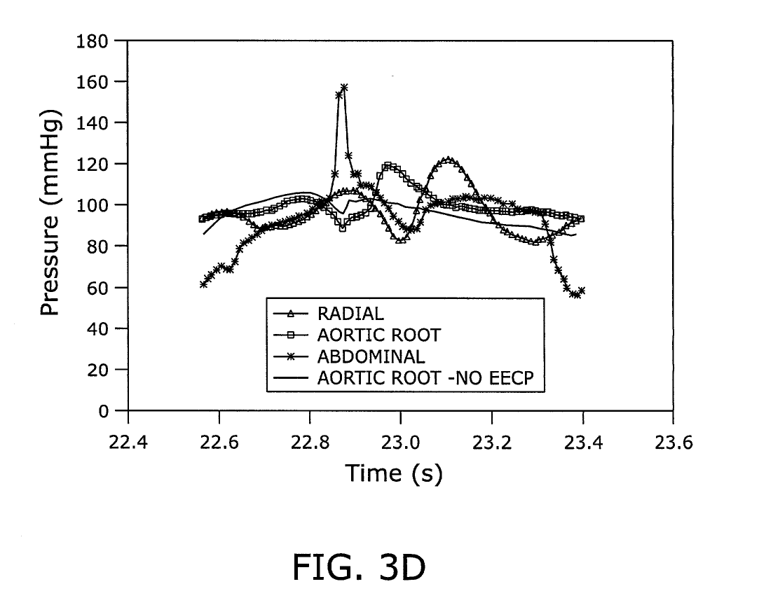

Pressure pulses at the radial artery and aortic root computed by the model (FIG. 3) with and without graded-sequential external compression from the lower abdomen to the foot clearly illustrate the hemodynamic effects of EECP. Compression of a “normal” subject (FIG. 3a) is contrasted to EECP in a patient with reduced ventricular function (FIG. 3b). In both cases, pressure is applied by a three-compartment cuff with maximum pressures of 200, 150 and 100 mmHg along the lower leg, upper leg, and lower abdomen, respectively. Note that in this instance of arterial counterpulsation (pressure application during cardiac diastole and release of pressure during systole) systolic pressure is reduced while diastolic pressure is augmented, leading to the combined effects of reduced ventricular afterload and enhanced coronary blood flow.

The effectiveness of EECP can be viewed in terms of the measures of merit defined previously. These results, computed for the “normal” subject, are shown in Table 4. Numbers shown in the table correspond to the fractional change in each measure from the case without compression and are defined so that they range in value from zero (no effect) to order one.

TABLE 4
Values for each of the measures of merit
for the baseline conditions given in Table 3.

| | Values under baseline conditions |
|---|---|
| MDP | 0.0782 |
| MSP | 0.0238 |
| EE | 0.373 |
| S | 3.22 |

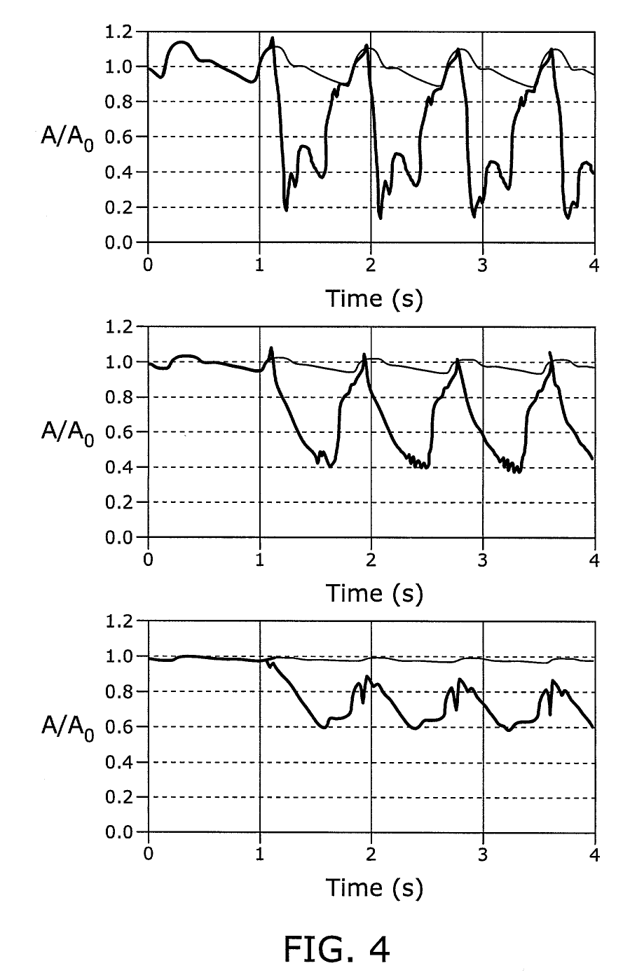

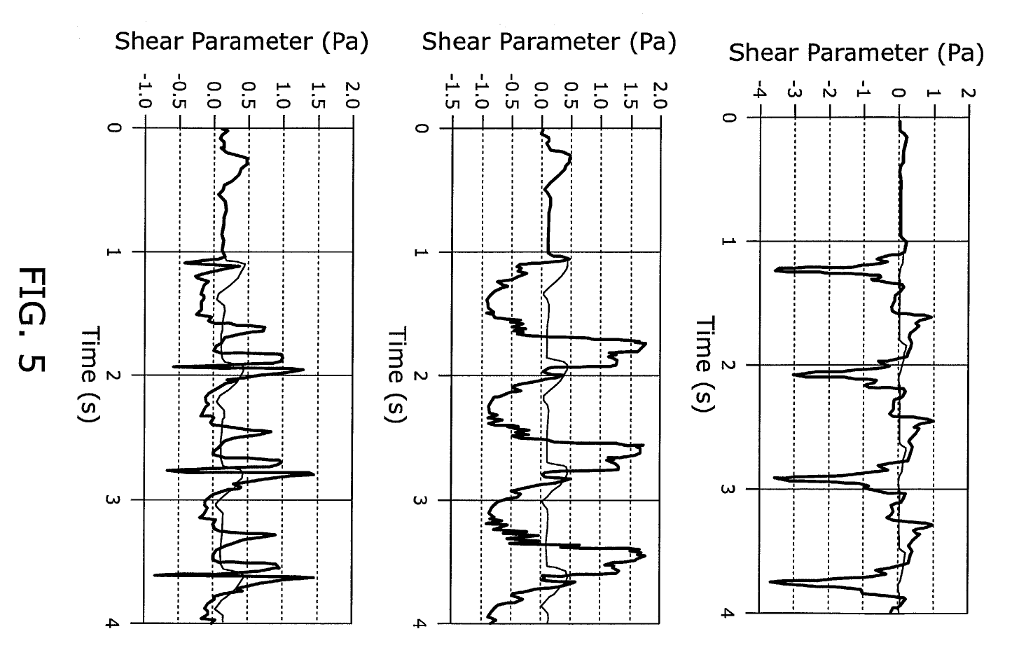

For this same condition of external compression, the time-varying arterial cross-sectional area and a measure proportional to the time-varying shear stress (see Eq. (23)) are plotted for three locations (lower abdomen, thigh, and calf) in FIGS. 4 and 5. During pressure application, the arteries collapse with sufficient speed to cause a flow reversal throughout much of the arterial network and a significant increase in vascular shear stress in the arteries of the lower extremity. The arteries in the lower abdomen and thigh (FIGS. 4(a) and 4(b), respectively) refill rapidly upon pressure release, even rising to slightly above normal levels due to the strong compression wave generated and its reflection from the peripheral vascular bed. During refilling, shear stress attains levels roughly 3- to 4-fold higher than under normal conditions at all three locations (FIG. 5). Features of particular interest in the context of endothelial function are the high shear stresses of reversing sign, and the significant arterial wall strain due to arterial collapse.

One way to elucidate the relative effects of the various compression parameters is by the sensitivity matrix of Table 5.

TABLE 5
Sensitivity matrix. Each numerical value represents
the fractional change in the particular measure of
merit [Δ(MM)/MMₘₑₐₙ] divided by the
fractional change in the parameter [ΔY/Yₘₑₐₙ]
as defined in Eq. (25). Note that a positive value
indicates an increase in magnitude of the measure of
merit for a positive change in the parameter.

| Y = | Pₘ | ΔP_{seg} | tᵣₐₘₚ | Δt_{seg} | T_{infl} |
|---|---|---|---|---|---|
| MDP | 1.01 | −0.140 | −0.107 | −0.086 | −0.887 |
| MSP | 1.26 | −0.512 | −0.147 | 0.067 | −0.059 |
| EE | −0.614 | 0.236 | −0.075 | −0.029 | 0.702 |
| S | 2.82 | −0.193 | −0.028 | 0.107 | 0.616 |

Considering that each measure of merit (MM) (e.g., mean diastolic pressure, MDP) is a function of each of the adjustable parameters (Y) (e.g., mean applied pressure), then an entry in the table (X) represents the change in the measure of merit [Δ(MM)] divided by the fractional change in the parameter value:

$$X = \frac{[ Δ ( M M ) / M {M}_{mean} ]}{[ Δ Y / {Y}_{mean} ]} \qquad ( 25 )$$

Large values indicate strong correlations between the measure of merit and the particular parameter. For example, a 10% increase in mean applied pressure (Pm) will produce an increase of 0.0078 (=0.1^{.}1.01^{..}0.0782) in MDP. This table is useful for identifying the parameters that, when varied, will have the greatest influence on the measure of interest.

While the dependencies are generally quite symmetric about the baseline case suggesting a nearly linear dependence, there is one notable exception. The time to initiate cuff inflation (T_{infl}) selected for the baseline case was near the optimum in terms of reducing mean systolic pressure. Thus, although T_{infl} has a strong influence on most of the measures of merit, increasing or decreasing it by small amounts from the baseline case does not appear to have much effect on MSP. Changes of larger magnitude, however, will have significant deliterious effects; e.g., if cuff inflation occurs earlier, before the end of systole, systolic unloading will be severely affected.

Mean applied pressure clearly has the greatest potential to enhance diastolic pressure and increase levels of shear stress, although increasing mean pressure probably has the largest negative impact on patient tolerance. Altering cuff inflation time also exerts an important influence, although some of its effects are counter-productive (e.g., when S and EE increase, MDP falls). Reducing pressure rise time (tramp) is also beneficial, although this may be difficult to accomplish in practice.

Discussion

The simulations of EECP presented here, provide insight into the dynamic processes that accompany EECP. Beginning near the end of systole, compression produces arterial collapse, sending a wave of retrograde flow up into the aorta, increasing pressure up as far as the aortic root and, presumably, augmenting coronary blood flow. When compression is released near the end of diastole, the arteries begin to refill, initiating a rarefaction wave that propagates toward the heart, reaching it at a time that produces systolic unloading. The extent of emptying of the leg arteries decreases toward the periphery, but corresponds to approximately half their normal arterial volume within the range of pressures tested here. Refilling to normal volumes is achieved in the most proximal arteries, but even at the levels of pressure used in these simulations, is incomplete in the lower leg. Increasing pressure applied to the calf up to 300 mmHg (results not shown) compromises refilling even further. The results in Table 3 demonstrate the potential for controlling mechanical events related to cardiac assist or vascular cell stimulation, and perhaps more importantly, show that optimization of the measures relating to cardiac function is not always consistent with optimization of the vascular stimulus.

In previous models of EECP, the arteries were represented as a collection of lumped elements and were therefore not capable of accurately capturing many of the phenomena associated with wave propagation through the arterial network and arterial collapse (Bai, J., Wu, D., Zhang, J. A Simulation Study of External Counterpulsation. Comput. Biol. Med.,. 24(2):145-156, 1994; Bai, J., Ying, K., Jaron, D. Cardiovascular responses to external counterpulsation: a computer simulation. Med. Biol. Eng. Comput., 30:317-323, 1992; each of which is incorporated herein by reference). The present model, though still discretized, solves the distributed differential equations and also incorporates the nonlinearities associated with arterial collapse and convective acceleration which are critical under conditions of EECP. Consequently, the model captures the influence of forward and backward propagating waves, can reproduce the complex impedance of real arterial networks (Ozawa, E. T. “A numerical model of the cardiovascular system for clinical assessment of the hemodynamic state.” Thesis, Ph.D., Massachusetts Institute of Technology, September, 1996; incorporated herein by reference), and thereby provides a means to examine the detailed flow dynamics associated with EECP. As seen in FIG. 4, the onset of compression at the lower leg sends a surge of blood toward the heart, producing the rapid rise in cross-sectional area in the thigh (see e.g., t=3.60 s in FIG. 4(b)) and the lower abdomen (t=3.64 s in FIG. 4(a)) just prior to compression of these regions. The abrupt fall in cross-sectional area in the calf (beginning at t=3.56 s, FIG. 4(c)) is followed by an equally abrupt rise in area, before the area decreases more consistently as pressure is maintained. The low frequency oscillation occurring in the iliac artery (t=2.9-3.2 s, FIG. 4(a)) is evidence of wave reflection from the proximal end of the aorta, causing some refilling while pressure is still maintained. These waves are highly damped, however, and are not seen in the thigh or calf regions.

These results, in terms of the magnitude of the effect observed in arterial blood flow and pressure, can to some extent be compared with previous observations. In the multi-center study, the hemodynamic effects of EECP were monitored by determining an “effectiveness ratio” defined as peak diastolic pressure minus end-diastolic pressure divided by peak systolic pressure minus end-diastolic pressure (Arora, R. R., Chou, T. M., Jain, D., Fleishman, B., Crawford, L., McKiernan, T., Nesto, R. W. The multicenter study of enhanced external counterpulsation (MUST-EECP): effect of EECP on exercise-induced myocardial ischemia and anginal episodes. J. Am. Col. Cardiol., 33(7):1833-1840, 1999; incorporated herein by reference). Using the aortic blood pressure trace, this ratio is 0.90 for our standard case (FIG. 3b) and 1.60 for the case with a compromised ventricle (“diseased”) simulation (FIG. 3d) compared to an average of 1.41±0.51 in the multi-center trial. Note that the patient values (1) were based on measurements with a finger plethysmograph and therefore are not directly comparable to our predictions, and (2) were obtained using maximum pressures up to 300 mmHg. In a separate study, most effects (e.g., change in cardiac output, ratio of retrograde to antegrade aortic flow) had nearly reached their maximal effect when the diastolic-to-systolic pressure ratio reached values in the range of one to 2 (Suresh, K., Simandl, S., Lawson, W. E., Hui, J. C., Lillis, O., Burger, L., Guo, T., Cohn, P. F. Maximizing the hemodynamic benefit of enhanced external counterpulsation. Clinical Cardiology, 21(9):649-653,1998; incorporated herein by reference).

We chose to study a range of pressures below those currently used clinically in recognition of the relatively high number of adverse experiences reported by patients receiving EECP. In the multi-center study (Arora, R. R., Chou, T. M., Jain, D., Fleishman, B., Crawford, L., McKiernan, T., Nesto, R. W. The multicenter study of enhanced external counterpulsation (MUST-EECP): effect of EECP on exercise-induced myocardial ischemia and anginal episodes. J. Am. Col. Cardiol., 33(7):1833-1840, 1999; incorporated herein by reference), 54.9% of patients experienced adverse effects, with the majority of these being device-related. The number of device-related adverse effects was reduced nearly 4-fold (from 37 to 10) in a separate group of patients in whom applied pressures were decreased from 300 mmHg to 75 mmHg. Our results indicate that significant hemodynamic effects, especially in terms of enhancing arterial shear stress and arterial wall strain, can be achieved with the use of considerably lower pressures, with mean values in the range of 150 mmHg.

Our assumption of constant venous pressure has several potential implications. Consider first the effect of compression on the veins of the lower extremity. The magnitude and frequency of compression will almost certainly cause these veins to be in a state of collapse throughout the cycle since venous valves prevent rapid refilling as occurs on the arterial side. Thus, during compression, venous pressure will be at or slightly elevated above central venous pressure, but during the relaxation phase it will be strongly negative. We anticipate that this would lead to an increase in mean limb flow but of unknown magnitude. A second effect of compression, secondary to the collapse of the veins of the lower extremities, would be a slight elevation of central venous pressure leading to enhanced venous return and activation of the atrial baroreceptors. The effects of these changes are difficult to predict with the present model, and deserve further attention. For the purpose of predicting the pulsatile changes in flow and cross-sectional area in the leg arteries, however, these changes on the venous side should have relatively little impact. Several additional simulations (results not shown) were conducted with end diastolic volume increased by 20 ml, and with venous pressure increased 5 mmHg. The latter produced results indistinguishable from those presented here. The increase in end diastolic volume led to an overall increase in arterial pressure by about 10 mmHg, but the pressure profile with EECP changed very little. The net effect would be a reduction in systolic unloading and an increase in diastolic augmentation.

Another potential source of uncertainty relates to the values for elastic modulus used for the arterial tree. Although we used the only data we were aware of in the literature³, these are only estimates and are therefore subject to error. Since the stiffness of the arteries under collapse is based on these estimates, it is possible that the pressures required to produce a certain degree of arterial emptying may also be uncertain. Add to this the subject-to-subject variability likely to be present, and it is apparent that these results should be used only as a rough guide to estimating the parameter values for any particular subject, and that some amount of empirical testing is essential in practice.

It is interesting to note that recent clinical results show benefits in cardiac function from as little as one hour of treatment per day. Under this protocol, Lawson et al., found that 17 out of 18 patients receiving EECP for as little as 36 one-hour treatments reported improvement in anginal symptoms, despite prior medical and surgical therapy (Lawson, W. E., Hui, J. C., Soroff H. S., Zheng, Z., et al. Efficacy of enhanced external counterpulsation in the treatment of angina pectoris. American Journal of Cardiology, 70(9):859-862, 1992; incorporated herein by reference). The results of the recent multi-center study involving 139 patients confirmed these findings and showed that EECP reduces exercise-induced ischemia and angina (Arora, R. R., Chou, T. M., Jain, D., Fleishman, B., Crawford, L., McKiernan, T., Nesto, R. W. The multicenter study of enhanced external counterpulsation (MUST-EECP): effect of EECP on exercise-induced myocardial ischemia and anginal episodes. J. Am. Col. Cardiol., 33(7):1833-1840, 1999; incorporated herein by reference). A 1996 study by Lawson et al. also showed improved exercise tolerance in 22 out of 27 patients with chronic stable angina (Lawson, W. E., Hui, J. C., Zheng, Z. S., Burgen, L., Jiang, L., Lillis, O., Oster, Z., Soroff, H., Cohn, P. Improved exercise tolerance following enhanced external counterpulsation: cardiac or peripheral effect? Cardiology,. 87(4):271-275, 1996; incorporated herein by reference).

While the mechanism by which patients accrue benefit from EECP treatments remains unclear, evidence points to the importance of factors other than the obvious mechanical ones that prompted early studies of EECP as an external cardiac assist method. It is now thought that the benefits of EECP may be related to the recruitment of collateral vessels in the coronary circulation, perhaps due to an increase in the synthesis and release of vascular growth factors (Soran, A. U., Crawford, L. E., Schneider, V. M., and Feldman, A. M. Enhanced external counterpulsation in the management of patients with cardiovascular disease. Clinical Cardiology, 22(3): 173-178, 1999; incorporated herein by reference).

Recently, Soran et al. have proposed that EECP may act by altering endothelial function due to changes in the level of shear stress in the arteries (Soran, A. U., Crawford, L. E., Schneider, V. M., and Feldman, A. M. Enhanced external counterpulsation in the management of patients with cardiovascular disease. Clinical Cardiology, 22(3): 173-178, 1999; incorporated herein by reference). Although EECP has been shown to increase the perfusion through the carotid and renal arteries by approximately 20% in one study (Applebaum, R. M., Kasliwal, R., Tunick, P. A., Konecky, N., Katz, E., Trehan, N., Kronzon, I. Sequential external counterpulsation increases cerebral and renal blood flow. American Heart Journal, 133(6):611-615, 1997; incorporated herein by reference), the effects of elevated shear on the synthesis and release of various cytokines and growth factors are clearly not restricted to the coronary vascular bed. Shear stress is elevated throughout much of the arterial system, especially in the arteries of the lower extremities by a combination of flow augmentation and reduced arterial cross-sectional areas, producing levels of shear stress up to more than four times normal values. These high levels of shear occur during both antegrade and retrograde flow (FIG. 5). While potentially damaging to the endothelium, these high shear stresses might also provide benefit by stimulating the release of shear-induced angiogenic factors from the arterial endothelium of the lower extremities. This has not previously been considered and clearly deserves further study.

In terms of designing optimal protocols for EECP, it is critically important to understand the mechanism by which myocardial function is improved. In particular, parameter variations that optimize the traditional measures of merit (reduction in systolic pressure and increase in diastolic pressure) are not always consonant with the desire to maximize the magnitude and spatial extent of changes in arterial shear stress in the lower extremity. These issues will need to be better understood before a rationale design of the EECP protocol is possible.

### Other Embodiments

Those of ordinary skill in the art will readily appreciate that the foregoing represents merely certain preferred embodiments of the invention. Various changes and modifications to the procedures and compositions described above can be made without departing from the spirit or scope of the present invention, as set forth in the following claims.

What is claimed is:

1. A method for treating a disease characterized by low blood flow by inducing angiogenesis, the method comprising steps of:
providing a patient suffering from a disease characterized by low blood flow;
attaching a compression apparatus to a body part of the patient; and
applying graded sequential compression to the body part of the patient using the compression apparatus, wherein the compression delivers a maximum pressure of less than 300 mm Hg.

2. A method for promoting wound healing, the method comprising steps of:
providing a patient with a wound;
attaching a compression apparatus to a body part of the patient; and
applying graded sequential compression to the body part of the patient using the compression apparatus, wherein the compression delivers a maximum pressure of less than 300 mm Hg.

3. The method of claim 1 or 2 wherein the graded sequential compression results in a reverse in direction of shear stress seen by the vascular endothelial cells of the patient.

4. The method of claim 1 or 2 wherein the graded sequential compression causes a 100% change in shear stress seen by the vascular endothelial cells of the patient.

5. The method of claim 1 or 2 wherein the graded sequential compression causes a 50% change in shear stress seen by the vascular endothelial cells of the patient.

6. The method of claim 1 or 2 wherein the graded sequential compression causes a 200% change in shear stress seen by the vascular endothelial cells of the patient.

7. The method of claim 1 or 2 wherein the graded sequential compression causes a 400% change in shear stress seen by the vascular endothelial cells of the patient.

8. The method of claim 1 or 2 wherein the graded sequential compression is sufficient to cause a temporary collapse of the large arteries of the body part to which the compression means is attached.

9. The method of claim 1 or 2 wherein the graded sequential compression delivers a maximum pressure of less than 250 mm Hg.

10. The method of claim 1 or 2 wherein the graded sequential compression delivers a maximum pressure of less than 200 mm Hg.

11. The method of claim 1 or 2 wherein the graded sequential compression delivers a maximum pressure of less than 150 mm Hg.

12. The method of claim 1 or 2 wherein the graded sequential compression results in retrograde flow in the arterial vasculature of the patient.

13. The method of claim 1 or 2 wherein the graded sequential compression is timed with the cardiac cycle of the patient.

14. The method of claim 1 or 2 wherein the graded sequential compression induces secretion of angiogenesis factors.

15. The method of claim 1 or 2 wherein the graded sequential compression induces secretion of at least one molecule selected from the group consisting of platelet-derived growth factor, fibroblast-derived growth factor, epidermal growth factor, vascular endothelial-derived growth factor, prostaglandins, NO, leukotrienes, and cytokines.

16. The method of claim 1 or 2 wherein the graded sequential compression induces secretion of growth factors.

17. The method of claim 1 or 2 wherein the graded sequential compression induces secretion of angiogenesis factors by vascular endothelial cells.

18. The method of claim 1 or 2 wherein the graded sequential compression induces secretion of angiogenesis factors by cells selected from the groups consisting of muscle cells, fibroblasts, epithelial cells, and smooth muscle cells.

19. The method of claim 1 or 2 wherein the compression apparatus is attached to at least one extremity of the patient.

20. The method of claim 1 or 2 wherein the compression apparatus is attached to at least one leg of the patient.

21. The method of claim 1 or 2 wherein the compression apparatus is attached to at least one arm of the patient.

22. The method of claim 1 or 2 wherein the compression apparatus is an inflatable bladder.

23. The method of claim 22 wherein the inflatable bladder may contain a gas.

24. The method of claim 22 wherein the inflatable bladder contains a liquid.

25. The method of claim 1 or 2 wherein the compression apparatus is a series of cuffs containing at least one inflatable bladder.

26. The method of claim 1 or 2 wherein the compression apparatus is a flexible, stretchable band capable of being under variable tension.

27. The method of claim 1 or 2 wherein the patient has peripheral vascular disease.

28. The method of claim 1 or 2 wherein the patient has cardiovascular disease.

29. The method of claim 1 or 2 wherein the patient has coronary artery disease.

30. The method of claim 1 or 2 wherein the patient has diabetes.

31. A method for treating a disease characterized by low blood flow by inducing angiogenesis, the method comprising steps of:
providing a patient suffering from a disease characterized by low blood flow;
attaching an apparatus to a body part of the patient for delivering a negative pressure; and
applying negative pressure to the body part of the patient using the apparatus.

32. A method for treating a disease characterized by low blood flow by inducing angiogenesis, the method comprising steps of:
providing a patient suffering from a disease characterized by low blood flow;
attaching an apparatus to a body part of the patient for delivering negative and positive pressure;
applying negative pressure to the body part of the patient using the apparatus; and
applying positive pressure to the body part of the patient using the apparatus.

33. A method for promoting wound healing, the method comprising steps of:
providing a patient with a wound;
attaching an apparatus to a body part of the patient for delivering a negative pressure; and
applying negative pressure to the body part of the patient using the apparatus.

34. A method for promoting wound healing, the method comprising steps of:
providing a patient with a wound;
attaching an apparatus to a body part of the patient for delivering negative and positive pressure;
applying negative pressure to the body part of the patient using the apparatus.; and
applying positive pressure to the body part of the patient using the apparatus.

35. An apparatus for compressing a part of a patient's body in order to induce angiogenesis or wound healing, the apparatus comprising:
a source of fluid;
a compression structure for receiving the fluid;
a control means for controlling the fluid to achieve inflation and deflation of the compression means, wherein the control means institutes inflation of the compression structure so that graded sequential compression of the body part results with a maximum pressure of less than 300 mm Hg.

36. The apparatus of claim 35 wherein the apparatus further comprises a blood oxygen detector.

37. The apparatus of claim 35 wherein the apparatus further comprises a pulse oximeter.

38. The apparatus of claim 35 wherein the apparatus further comprises an EKG detector.

39. The apparatus of claim 35 wherein the apparatus further comprises a blood pressure detector.

40. The apparatus of claim 35 wherein the apparatus further comprises a means for heating or cooling the liquid.

41. The apparatus of claim 35 wherein the apparatus further comprises a means for accelerating the withdrawal of fluid from the compression means.

42. The apparatus of claim 41 wherein the means for accelerating the withdrawal of fluid from the compression means comprises a vacuum pump.

43. The apparatus of claim 41 wherein the means for accelerating the withdrawal of fluid from the compression means comprises a negative pressure reservoir.

44. The apparatus of claim 35 wherein the compression structure comprises a means for mounting compression means on the body part.

45. The apparatus of claim 44 wherein the means for mounting is Velcro®.

46. The apparatus of claim 44 wherein the means for mounting is selected from the group consisting of buttons, snaps, elastic bands, and zippers.

47. The apparatus of claim 35 wherein the fluid is a gas.

48. The apparatus of claim 35 wherein the fluid is a liquid.

49. The apparatus of claim 35 wherein the source of compressed fluid is a gas compressor.

50. The apparatus of claim 35 wherein the source of compressed fluid is a tank of pressurized gas.

51. The apparatus of claim 35 wherein the compression structure is a balloon.

52. The apparatus of claim 35 wherein the compression structure is a bladder.

53. The apparatus of claim 35 wherein the control means comprise s a computer.

54. An apparatus for compressing a part of a patient's body in order to induce angiogenesis or wound healing, the apparatus comprising:
at least one flexible band;
a means for mounting said band on the body part;
a control means for controlling the tension in the band and thus the band's resulting pressure on the body part.
